(19) United States
(12) Patent Application Publication
(10) Pub. No.: US 2006/0074794 A1
(43) Pub. Date: Apr. 6, 2006

(54) Method, system, and computer program product for structuring and allocating payments on a loan with secured repayments

(75) Inventor: Richard Peter Nespola JR., Washington, DC (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FREDDIE MAC, McLean, VA (US)

(21) Appl. No.: 10/951,600

(22) Filed: Sep. 29, 2004

(51) Int. Cl. G06Q 40/00

(52) U.S. Cl. 705/38

(57) ABSTRACT

A method of making and securing a loan, including the steps of: taking a loan by a borrower; and lending money secured by real estate to the borrower. The loan terms include the borrower being responsible for the debt; the borrower has an option to request another entity make a predetermined payment on the borrower's behalf; and the another entity takes an equity interest in relation to the amount paid by the another entity on behalf of the borrower.

### BACKGROUND OF THE INVENTION

1. Field of the Invention

The present invention generally relates to financial methods, systems, and computer program products for processing financial information and for securing repayment of loans. More particularly, the present invention relates to systems and methods for structuring and allocating responsibility for payments on loans the repayment of which are secured by a lien, or other legal instruments.

2. Discussion of the Related Art

Homebuyers apply for mortgages from primary market mortgage lenders such as banks, thrifts (which include savings and loan associations and savings banks), mortgage companies, credit unions, and online lenders. The primary market mortgage lender evaluates the homebuyer's ability to repay the mortgage, and if the lender's criteria are met, arrangements are made to make the loan. The transaction between the lender and the borrower culminates in what is called “the closing.” By signing the closing documents, the lender agrees to fund the purchase of the home and the homebuyer agrees to pay the mortgage as negotiated. Once the loan is closed, the funds are transferred from the primary lender to the property seller.

After the closing, the primary lender may either hold the mortgage in its portfolio (along with other loans it has made) or sell it in the secondary mortgage market. When primary mortgage lenders sell loans in the secondary market, they generally sell them as loans to a secondary market institution like the Federal Home Loan Mortgage Corporation (“Freddie Mac”). The primary lender may then use the proceeds of the sale to make new loans to other homebuyers in their community. As shown below, when the secondary market institutions buy mortgages that meet specific underwriting and product standards, they often package those qualifying loans into mortgage-backed securities (MBS) which they sell to investors on Wall Street.

In the case of MBS, the secondary market institutions will guarantee timely payment of principal and interest to MBS investors. Investors value secondary market institution guarantees and the homogeneous quality and liquidity of MBS over individual mortgages. Because of these attributes, investors in MBS are willing to accept a slightly lower yield as the funds pass through to them from the secondary market institution.

In addition, secondary market institutions provide more finds to the primary mortgage market through portfolio investment. By investing in mortgages, secondary market institutions attract funds for primary market mortgage lenders from investors who would not otherwise invest in the U.S. residential mortgage market, or who might be averse to prepayment risk.

Secondary market institutions help make mortgage financing available to homeowners across America by keeping the cost of mortgage financing as low as possible. They do this by providing various investment opportunities to the marketplace through two types of securities:
Mortgage-backed securities: Securities that represent an interest in a pool of loans, such as residential mortgages.
Debt securities: Securities issued by the secondary market institution to raise funds. The issuer promises to pay interest and to repay the debt on a specified date. These debt securities are issued in the U.S., Europe, and Asia.

Secondary market institutions use the funds from sales of these securities sales to purchase more loans from primary lenders. In this way, secondary market institutions are constantly replenishing the pool of funds available for new loans, which allow primary lenders to use the cash they get from the secondary market institutions to originate new mortgages.

Secondary market investors demand a predictable stream of monthly loan repayments with steady loan amortization. This steady amortization is achieved by:
(i) uniform underwriting standards: borrower (income, credit history); and asset type (home, car);
(ii) originator/servicer credit enhancements (reps and warranties that loans sold meet lending criteria with guaranteed repurchase if do not); and
(iii) mortgage insurance where equity less than 20% based on loan to value (LTV) ratio.

The secondary market could accommodate loans with irregular monthly loan repayments, but only through a retained portfolio set up for purchases of mortgages without consistent payment streams. However, because irregular monthly payment streams do not conform to the TBA standard set forth by the Bond Market Association (BMA), the loans held in such a retained portfolio are never eligible for securitization. The secondary market practice of repackaging loans and directing downstream cash flows from borrowers through servicers (and other payment conduits) to investors makes flexibility difficult for the following reasons:
(A) Loan servicing is based on collection of monthly payments consisting of: Principal, Interest, Tax and Insurance escrow.
(B) Servicers collect their fee to service the loan from a spread percentage on monthly borrower payments; and
(C) Servicing systems and conduits are not designed to handle irregular payments.

Under existing conventional loan programs, irregular payment amounts are likely to result in mortgage payment default and legal processes to seize control of the asset to force repayment or convert the asset into cash through a forced sale; however,
(A) Borrowers (that may, but for a steady income, otherwise qualify for a mortgage loan) may want or need flexibility in monthly mortgage payment;
(B) Under existing conventional loan programs, adjustments of a borrower's monthly payment is currently achieved through the inefficient process of loss mitigation efforts to reduce foreclosure credit losses only after a payment default. ***However, these efforts are not really “flexible” as this is more like a note modification/repayment work out. That is, these adjustments do not provide payment flexibility to the borrower.

In opposition to the investor's demand for a predictable stream of monthly loan repayments is a consumer demand for payment flexibility. Payment flexibility is especially important to lower income borrowers or borrowers who are subject to disruptive life events that affect their cash flow (death, divorce, medical issues, etc.) Examples of conventional approaches to flexible mortgage programs are discussed below.

The Federal National Mortgage Association's (“Fannie Mae's”) PAYMENT POWER™ mortgage provides borrowers with the ability to skip complete mortgage payments, including taxes and insurance up to two times a year, and up to ten times over the life of the loan (assuming a 30 year amortization). The skipped payments may be consecutive. However there is a required hiatus of 90 days between the next skipped payments if the consecutive option is exercised. Also, mortgage payment histories must be current, and consecutive for 90 days. Mortgages must be a Desktop Underwriting (DU) acceptable mortgage. Eligible mortgage types and properties are limited to one and two unit homes and condos for purchase, rate/term refinance, or cash out refinance. LTV limits are up to 95% for purchase and rate/term refinance mortgages, and limited to 90% LTV on cash out refinances.

Fannie Mae's PAYMENT POWER™ mortgage extends to its lending partners an additional 0.125 basis point (bps) fee for servicing these types of mortgages. Borrowers can opt for the option of taking a higher rate for these types of mortgages, paying the fee at settlement, or having the option of being charged a usage fee based upon the amount of their home's unpaid principal balance (UPB). Overall, borrowers pay roughly 375 bps more in rate for the PAYMENT POWER option, which is equivalent to a 1.50% delivery fee. Additional usage fees are also applicable from lenders, ranging from $100 to $225 for UPB up to $120K, $170 to $295 for UPBs from $120K to $215K, and $230 to $355 for loans from $215K to the Conforming Limit. This double dipping is penalizing the borrower for exercising the option granted to them with this mortgage option and lines the pockets of the seller/servicer.

The Fannie Mae PAYMENT POWER™ mortgage creates a capitalized balance when the borrower exercises the skip payment option. The skipped payment, along with the fee if applicable, are added to the balance, and re-amortized. As a skip payment mortgage effecting cash flows, pass-through and prepayment behavior, Fannie Mae's program is not “to be announced” (TBA) eligible. PAYMENT POWER™ mortgages are structured with a rider to the security instrument that permit the skip payment provision and the capitalization of the skipped amount applied to the UPB.

FIG. 1 illustrates the way in which Fannie Mae's PAYMENT POWER™ mortgage negatively impacts the borrower utilizing its skip pay option, relative to a normal fully amortizing payment. Due to recapitalization of the skipped payment back into the unpaid balance of the loan, with Fannie Mae's PAYMENT POWER™ mortgage the borrower now has to pay an additional amount per month over time.

Other conventional approaches include the Fannie Mae HOME STAY™ and the JP Morgan Chase/General Electric Mortgage Insurance Corporation (GEMICO) ‘Mortgage Payment Protection Insurance’ (MMPI) program. These programs are rooted in a traditional insurance approach to covering a borrower's inability to pay their mortgage due to economic hardship caused typically by unemployment. These programs, which require the borrower to pay a monthly fee or insurance premium, provide coverage in the event of job loss to borrowers. However, providing borrowers with a single financed premium option is not endorsed by either secondary market institutions such as Freddie Mac or Fannie Mae as they violate predatory lending laws.

In addition, HOME STAY™ and MPPI have eligibility requirements. These conventional programs require that the borrower fund the insurance premium for six months before the policy becomes effective. The borrower must prove that they are unemployed before the protection payments kick in, which may take up to 90 days from the time of notification. This may cause serious delinquency reporting issues and place the borrower in default and jeopardize his/her credit rating. As well with these programs, any co-borrower income is used to offset the amount paid out for the insurance claim. If a co-borrower makes enough money to cover the mortgage payment, a significantly adjusted insurance payment will be provided. Additionally, the borrower must prove that they are unemployed and seeking work—evident by the requirement to qualify for unemployment insurance. Borrowers who are self employed are not eligible for this type of insurance. The payment caps are typically set at six months, and the amounts range from $2500 a month with HOME STAY™ or up to $5000 a month with GEMICO.

Unlike the previously described programs that offer unemployment insurance, payment protection, or the ability to skip payments, Wells Fargo Home Asset Management^{SM} Account offers a mortgage with a simultaneous second home equity line of credit (HELOC) available to the borrower to use as they see fit. Positioned as a mortgage tool to leverage the asset of home equity, borrowers are instantly provided a HELOC in the amount of their down payment at no charge. It is only at the time that the borrower taps the HELOC, that the interest rate associated with the HELOC is applied to the amount.

Additionally, any incremental adjustment in appreciated value in the home is also applied to authorize a higher line of credit in the HELOC balance, along with all of their principal payments, for the homeowner's use as they see fit. While this program is not specifically linked to mortgage payment protection, it is a means for the borrower to leverage the equity they have established in their home without refinancing and facing closing costs. As well, there is no burden of proof for the borrower in times of hardship. The HELOC is tied to a checking account or a debit card issued by Wells Fargo.

However, interest rates on HELOCS are set at a variable rate considerably higher than that of the first mortgage. While the borrower has an option to convert the rate into a fixed rate HELOC at a later date, the actual rate set is not known until exercise of the option. Additionally, there is a $75 annual fee that the borrower has to pay in order to participate in the program. If the borrower closes the HELOC within the first three years following origination, there is a $500 deferred origination fee assessed. This program has high Fair, Isaac & Co (FICO) score requirements, and is actively targeted toward upper income borrowers, not those in affordable tracts.

Another type of conventional art is called Shared Appreciation Mortgages (SAMs). SAMs represent a significantly more rigid approach toward providing borrowers with lower payments in return for equity and the potential for shared appreciation. SAMs work by providing the borrower a simple reduction in the interest rate (e.g., 0.375%) in exchange for a determined equity share in the borrower's home. These programs do not provide the borrower with the ability to choose when to exercise the option of exchanging equity for a lower payment. Additionally, the borrower is still obligated to make full payments regardless of times of hardship or financial uncertainty.

Halifax Bank in the United Kingdom offers a flexible mortgage program that includes the establishment of a reserve based on available equity in the property. Borrowers can miss a payment or under-pay as long as they pay six full payments a year and their reserve of payments covers the underpayment. The Royal Bank of Scotland offers a flexible mortgage program that includes the ability for the borrower to request to take a payment break of up to six months (after the first six months of the loan). The bank grants the request based on satisfactory conduct of the loan. These mortgage products, sometime known in the United Kingdom as Australian-type mortgage products are based upon the borrower actually remitting curtailments, but instead of applying those funds directly to pay down the principal balance, the funds are held in a reserve account to subsidize the payment at a later date. However, with these products, a borrower either has to have equity in the property and/or has to overpay in order to build up sufficient funds to skip a payment. Also, the cash flows associated with these mortgage products are not acceptable in the U.S. securities market, because of investor rights to all payments. A funds reserve like those used in the United Kingdom is incompatible with the U.S. secondary market prepayment speeds and resulting payoffs for these mortgages.

Thus, what is desired, as discovered by the inventor, is a method, system, and computer program product that provides repayment flexibility to borrowers while maintaining a predictable stream of monthly loan payments to secondary market investors. That is, what is desired is a mortgage instrument, and attendant systems, that
(A) guarantee the investor a predictable and steady cash flow; or
(B) in periods where the cash payment is less than the contractual amount, transfer other valuable property to the investor, such as an equity interest in the borrower's property. The following is a discussion of prior art that attempts to balance the desires of the secondary market investors with the needs of borrowers.

### SUMMARY OF THE INVENTION

The present invention is directed to a method, system, and computer program product relative to managing a loan. The method includes 1) taking a loan by a borrower; and 2) lending money secured by real estate to said borrower. Loan terms include a) the borrower being responsible for the debt; b) the borrower having an option to request another entity make a predetermined payment on the borrower's behalf; and c) the another entity taking an equity interest in relation to the amount paid by the another entity on behalf of the borrower. The debt may be related to real property, personal property, or other assets.

### DESCRIPTION OF THE FIGURES

The features and advantages of the present invention will become more apparent from the detailed description set forth below when taken in conjunction with the drawings in which like reference numbers indicate identical or functionally similar elements.

FIG. 1 illustrates how Fannie Mae's PAYMENT POWER™ impacts a borrower;

FIG. 2 is flow chart according to an embodiment of the present invention;

FIG. 3 illustrates a borrower remittance pattern through out the course a loan's history according to one embodiment of the present invention;

FIG. 4 illustrates how home price appreciation greatly enhances revenues for the secondary market institution and return on investment in the borrower property over time according to one embodiment of the present invention; and

FIG. 5 is a block diagram of a computer associated with the present invention.

### DETAILED DESCRIPTION OF INVENTION

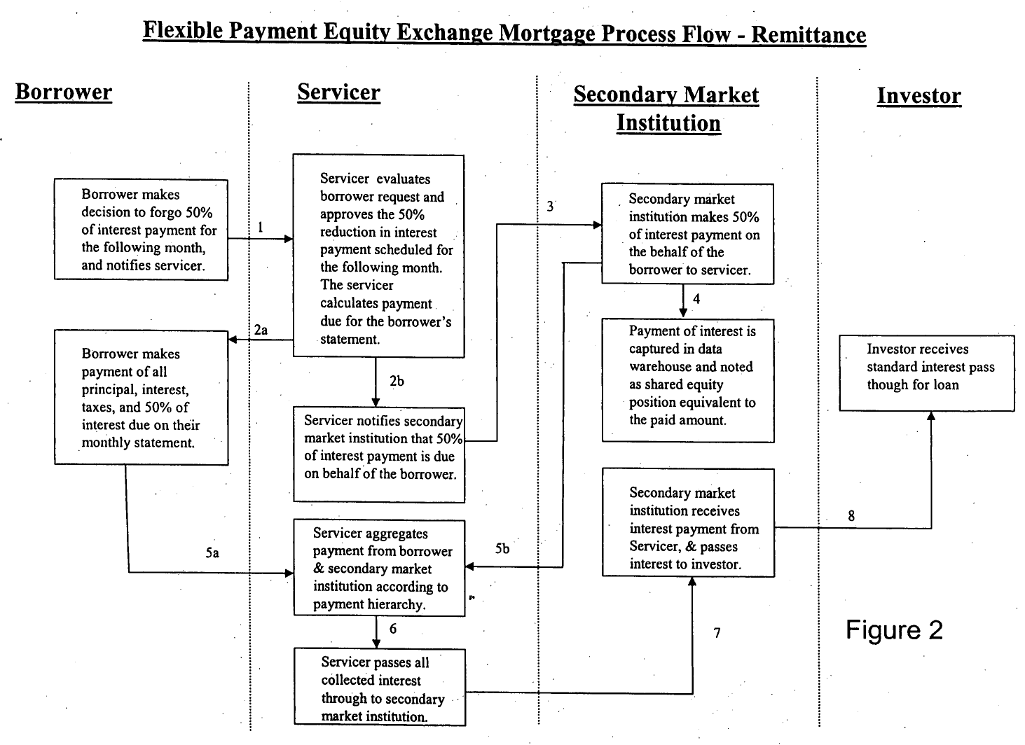

FIG. 2 is a flow chart corresponding to one embodiment of the present invention. A borrower qualifies for and obtains a loan from a lender, which may or may not be resold to a loan servicer (steps not shown). The loan may be identified as being a “flexible payment equity exchange mortgage” at inception or may be converted to a “flexible payment equity exchange mortgage.” The borrower notifies the lender/servicer to forgo a percentage of an interest payment for the following month (Step 1). The percentage may be fixed by the loan agreement or may be selected by the borrower. If selectable, the percentage may be characterized by a predetermined upper limit (e.g., 50%). In alternative embodiments, the borrower may elect to defer payments on principal instead of interest, or defer payments on both principal and interest. Alternatively, the borrower may defer payments on taxes or insurance. In other embodiments, a life time cap on the number of deferments is a feature of the loan. In other embodiments, deferments are only allowed during a predetermined portion of the loan (i.e., the first 5 years). In other embodiments, a life time cap on the dollar amount of the deferments is a feature of the loan. In a preferred embodiment, the borrower can utilize this payment option three times a year, with a life time cap of 18 times during the loan's existence.

The lender/servicer evaluates the borrower's request (Step 2A). If the loan status is compliant with a predetermined set of criteria related to current LTV and payment history, the lender/servicer approves the requested reduction in payment. In one embodiment, the lender/servicer can approve a reduction less than an amount requested by the borrower. The lender/servicer then calculates the payment due (i.e., the amount the borrower has to remit for the monthly payment) for the borrower's statement. The lender/servicer then notifies the secondary market institution that has guaranteed the borrower's loan that payment is due on behalf of the borrower (Step 2b).

The borrower, having been notified that the lender/servicer agrees to the lower payment, makes a payment that includes principal, interest, taxes, and the agreed upon interest payment (Step 5a). In other embodiments, the borrower may also defer payments on principal, taxes, or interest. Meanwhile the secondary market institution makes a payment to the lender/servicer that equals the amount of interest (or if applicable in other situations, principal and interest) deferred by the borrower (Step 3). The servicer/lender aggregates the payment from the borrower and the secondary market institution (Step 5b) and passes at least a portion of the collected interest to the secondary market institution (Step 6). The secondary market institution receives and passes the interest payments to the secondary market investors per a predetermined process for dividing and bundling loans (Step 7). That is, mortgages of the present invention may be pooled together or may be pooled with other types of mortgages. The secondary market investors receive standard pass-throughs for the loan (Step 8).

The secondary market institution captures in a data warehouse records of all interest payments made on behalf of the borrower (Step 4). From this data, a shared equity position is calculated. (i.e., Total P&I−Remitted Borrower P&I=Remaining Balance of Interest Due by Freddie Mac). This is the equity share amount equal to the interest payment forgone by the borrower. In one embodiment, this equity share amount is not based upon the future appreciated value of the home at the time of calculation. The only time the future value is calculated is at the point of home sale, and the purchase price reflects the appreciation of the equity share.

In alternative embodiments, the borrower is not required to notify the lender/servicer of any underpayment. Underpayments result in automatic payments by the secondary market institution on behalf of the borrower. In another alternative embodiment, the lender/servicer and the secondary market institution are the same entity.

An example of the process shown in FIG. 2 follows. On a $200,000 loan at 6%, the borrower can pay as little as $500 in interest, while the secondary market institution pays the remaining $500. The $500 paid by the secondary market institution is not actively rolled into the UPB of the mortgage. Instead this amount is counted as an equity share valued at $500. Thus, at the time that the secondary market institution pays the interest, the secondary market institution now owns $500 of the borrower's property. In one embodiment, this share increases/decreases in value with the change in market value of the home. In one embodiment, the share appreciation is measured from the time of the flexible payment by the secondary market institution. In another embodiment, the share appreciation is measured from the time of loan origination. This relationship will be established using a note addendum, rider, or lien instrument.

In some embodiments the entity guaranteeing the loan and making payments on behalf of the borrower is an entity other than the secondary market institution that passes collected interest to secondary market investors.

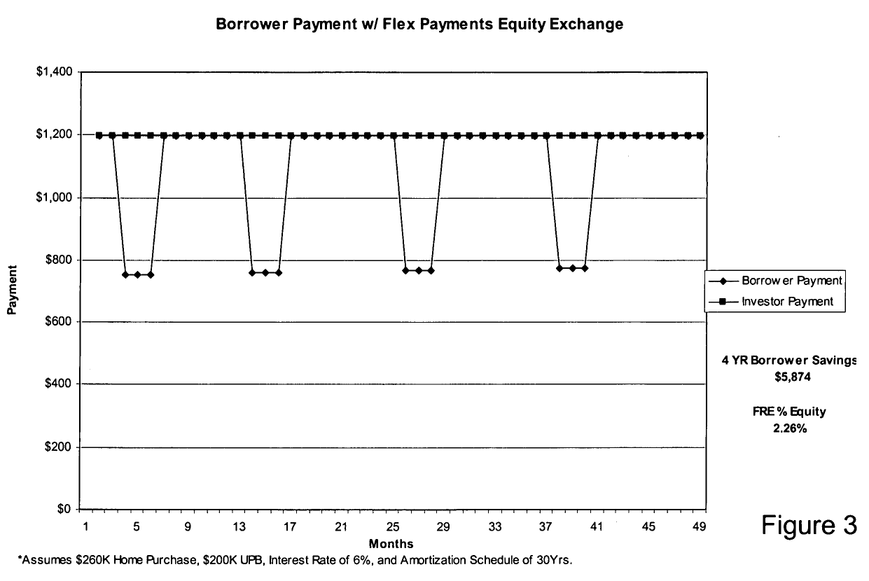

FIG. 3 illustrates a borrower remittance pattern through out the course a loan's history. FIG. 3 is indicative of the way in which the payments would be made if the borrower exercised the equity exchange option of the present invention for three consecutive months, reducing their overall payment to 50% of the interest due during that period of time. Additionally, FIG. 3 illustrates that there are no material effects to the investor pass-through of principal and interest from a standpoint of securitization, creating predictability for investors in the secondary market.

In one embodiment, the present invention would only assess appreciation at the time of home sale, and would not request equity reimbursement during the process of a refinance. In another embodiment, equity reimbursement may be demanded by the secondary market institution or may be volunteered by the borrower. Given a home purchase price of $260K, in seven years (assuming a market appreciation of 8.6%), the home's value will be roughly $426,500, an increase of 64%. At the seven year mark, the secondary market institution's total initial equity in the house of $8,159 (assuming the borrower maximizes equity exchange option annually for five years will be valued at $13.4K. This represents a considerable benefit to corporate revenue and in additional efforts to subsidize more borrowers using the program.

There are various ways for the borrower to pay back the deferred payment. In one embodiment, the borrower may purchase the equity back if they want, with or without a penalty. Other options would be for the borrower to purchase back the equity at the time of a sale (with appreciation/depreciation accounted for), at refinance without appreciation after a certain number of years, at appreciation within a certain number of years, or until default/REO if the loan becomes non-performing. Other options for borrower pay back may also be used.

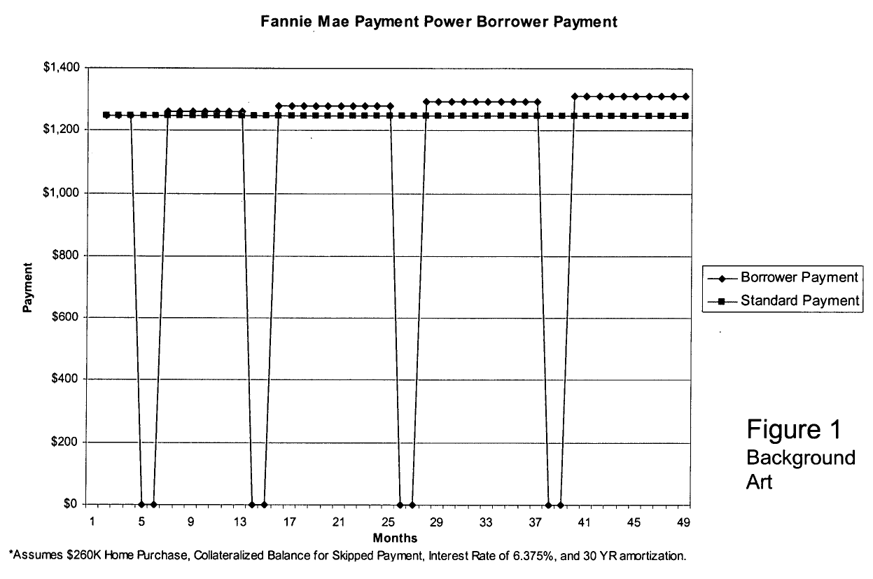

Referring back to a conventional approach, FIG. 1 illustrates that there is a tremendous amount of volatility for borrower cash flow with conventional approaches. However, if one were to overlay FIG. 3 on FIG. 1, one could see the benefits of both payment duration, and reduced cost over time for the invention of FIG. 2 vs. conventional approaches such as Fannie Mae's PAYMENT POWER™ mortgage. This is evident because there is a constant remittance for the borrower with the present invention, while Fannie Mae's PAYMENT POWER™ mortgage creates a higher borrower payment going forward, affecting cash flows. With the present invention, there is no volatility in the amount remitted.

Another example of how the present invention compares to conventional methods (e.g., Fannie Mae's PAYMENT POWER™ mortgage) is discussed below. The comparison assumes a $260,000 purchase price; a $200,000 UPB; 30 YR SFFR at 5.75%; a 0.375% rate increase for Fannie Mae's PAYMENT POWER™ ; a 0.125% additional servicing spread for Fannie Mae's PAYMENT POWER™; a $295 usage charge per incident for Fannie Mae's PAYMENT POWER™; a program usage two times a year for two years (at months 3, 4, 12, 16); and $250 taxes & insurance. The total borrower payments after five years (including missed payment savings) is $85,148.44 for Fannie Mae's PAYMENT POWER™ and $83,127.99 under the present invention, a difference of $2020.45. The cause for the higher total borrower payment with Fannie Mae's product is related to a higher note rate (6.156% with the rate add-on and higher servicing fee), and incrementally higher capitalized balances, which have to be re-amortized following the inclusion of each skipped payment into the UPB. The original payment for Fannie Mae's product was $1469.27 per month, but jumped to $1505.42 per month following the skipped payment inclusion in the UPB, whereas the monthly payment with the present invention remained level at $1469.22 per month for the borrower.

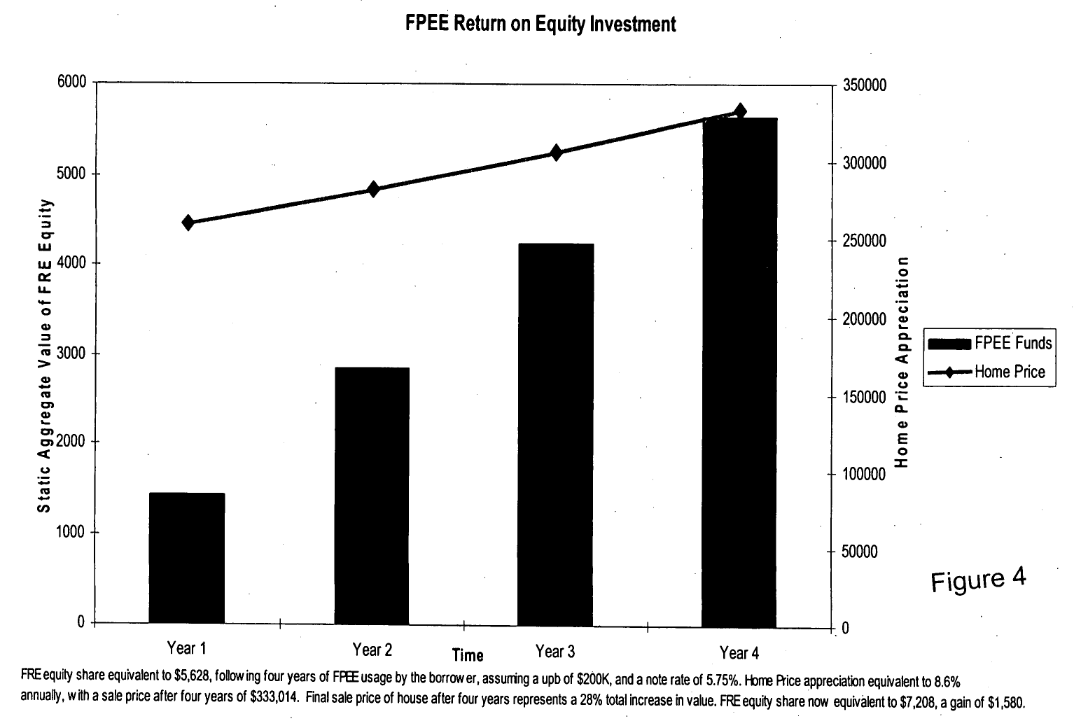

FIG. 4 illustrates the way in which home price appreciation enhances revenues for the secondary market institution which operates in accordance with the method of FIG. 2. This model assumes three equity exchange events a year over a four-year period. The model also assumes a home price appreciation of 8.6% (National Average) year over year for the home. In line, the equity exchange value increases at the multiple, while also growing from additional equity exchanges.

The invention shown in FIG. 2 has the benefit of maximizing cash flow for first time or low income homebuyers while allowing homebuyers to protect their credit rating and the investment they have in their homes by allowing secondary market institutions to provide payment assistance to these first time or low income homebuyers on an as-needed basis. This is accomplished by allowing home owners to take advantage of high home price appreciation rates where, across the country, the national average for home price appreciation is hovering at roughly 8.6%. The present invention also mitigates exposure of the lender/servicer or secondary market institution to costly non-performing loan (NPL) servicing or foreclosure proceedings by insuring that payments are consistently made on behalf of the borrower when those payments are needed. Specific advantages follow:

Borrower Advantages
1. No increase in borrower payment: With the present invention, the advanced interest is not capitalized into the UPB of the first note, providing borrowers with an unchanged amortization schedule and level payments.
2. The borrower has no burden of proof to establish with an insurance provider that he/she is facing a hardship. This provides ultimate flexibility for borrowers to pay for unexpected costs associated with home repairs, disruptions in cash flow, or unemployment.
3. The borrower can exercise the option to forgo a portion of their interest payment (e.g., 50%) at any time from the period of origination, and up to a predetermined number of times (e.g., 3) a year, with a predetermined lifetime cap on the number of occurrences (e.g., 18 over 30 years or 9 over 15 years) over the life of the loan.
4. There are no additional usage fees when the borrower wants to exercise the option to reduce their monthly payment, whereas conventional programs result in charges of anywhere from $100 to $355 per instance depending upon the UPB of the loan.
5. Borrowers have an opportunity to utilize the equity they have established in their home without being subject to high variable interest rates associated with HELOCS or carrying additional debt. As well, the likelihood that borrowers will abuse the available equity in their home as they might abuse the available balance in the HELOC is limited, because of the structure of the offering being limited to a predetermined amount of the interest due.
6. The interest payments are considered tax deductible. Insurance programs require a monthly payment into escrow to fund the premium for their programs, which are not tax deductible.
7. The borrower has a trusted entity with the secondary market institution being their equity partner. The secondary market institution is a financial services company who has the ability to securitize the borrower's mortgage in the conforming marketplace because the equity exchange contract is part of the mortgage document. Third party individuals cannot provide securitization of the borrower's asset, making any such endeavor more expensive for the borrower. Additionally, other parties potentially involved (e.g., mortgage insurance companies) will not participate in sharing the investment risk with an unknown/unsecured entity.

Investor Advantages
1. Conventional skip pay mortgages are not TBA eligible, whereas the present invention can be structured in a way that complies with TBA eligibility rules through the use of a note addendum, rider, or lien. Alternatively, non-standard pooling may be used instead of TBA eligibility as an option as some pay-up possibilities may be realized. In view of human nature and market behavior, it is not anticipated that the offering will affect prepayment speeds positively, or negatively.
2. Use of the present invention will increase the likelihood of good loan performance, and consistent pass-through due to subsidization. That is, individuals who face hardship or have a need to manage their cash flow will have to decide whether or not to exercise an option of making a payment or not. Having the flexibility to reduce monthly expenditures associated with a mortgage payment will likely enable them to get back on the feet financially, and meet their next obligation. As well, the mortgage underwriting process verified that they were capable of paying back the loan. In the standard process, if there is a disruption in payment, the loan will go into default. However, with the present invention, the borrower has the ability to reduce his or her payments without the fear of going into default—thus creating a better situation to mitigate foreclosure and increase positive mortgage payment behavior.

The present invention can be configured as an option which can be associated with any mortgage within a secondary market institution's suite of offerings. The present invention can be positioned to appeal to a wide variety of borrowers, ranging from those with a great deal of financial sophistication to those that are qualified for affordable lending products. Additionally, the present invention is well suited for borrowers with highly seasonal incomes—educators, construction workers, those that are self-employed, or for single headed households where income may vary from a time to time.

The following are examples of key differences to other credit protection/payment protection services offered in the marketplace:

Credit Card Payment Workout Programs/Mortgage Workouts—The present invention provides an exercise option for borrowers to use at their discretion over the life of the loan. It is a distinct program option established in the mortgage document/note that enables the borrower to enter into an agreement with the note holder to exchange a portion of the payment due for an equity share in the borrower's property. It is not a workout provision, or forgiveness of debt provision, nor is it a note modification. Mortgage/Credit Card Workout programs are fundamentally different due to the fact that they change the payment characteristics associated with the allocated debt. Workouts typically involve modifying the mortgage document or the original payment terms agreed upon by the lender or the borrower. They do not constitute an option to the borrower to exercise at will. Rather a workout is triggered by a financial hardship that causes an inability to make the requisite payments as originally agreed upon. There is usually a note modification or restructuring of the payment terms. For a mortgage, this is typically triggered by the loan going into default. As a way to salvage the mortgage and to keep the borrower in his or her home, the repayment terms are modified to meet the needs of the borrower. When this action takes place, the note is no longer valid for inclusion in a mortgage pool, and must be pulled from its assigned security

For the present invention, this is not the case as the mortgage option is exercised by the borrower in accordance with the original repayment terms and conditions with no residual effect to the mortgage pool or the investor in the mortgage pool. As well, no modification is required to adjust the payment terms of the mortgage to fit the need of the borrower's payment requirements, as this option exists in the mortgage document/note.

Debt Cancellation Insurance/Borrower Payment Protection—Unlike these insurance programs, the present invention is inclusive in the mortgage note. Thus, it is not necessary for the borrower to purchase additional coverage or insurance. Also, the present invention is flexible, and can be utilized over the life of the loan, whereas payment protection insurance and debt cancellation insurance are used at specific periods in time, and may not be exercised again past their limited duration. Additionally, with the present invention the borrower does not have to pay a monthly premium for coverage, as the flexible payment equity exchange option is part of the mortgage instrument.

Of significant importance is the recognition of limitation associated with payment protection insurance and debt cancellation insurance in relation to participation. These insurance programs are only available to qualified borrowers with limits placed on employment, age, and amount. The present invention does not have these limitations, and is open for all borrowers who qualify for the mortgage. Additionally, unlike many payment protection insurance and debt cancellation insurance programs, the present invention does not preclude the borrower from exercising the flexible payment option if the co-borrower can supplement the payment. Finally, there must be a qualified hardship for the insurance programs to operate. The borrower must provide proof of the hardship (e.g., filing for unemployment insurance.) In contrast, the present invention can be exercised by the borrower at will.

Unknown third party involvement—the possibility exists that an individual can assert a lien on the borrower's property in the amount of any money leant to the borrower in a time of need, and then adjust that amount as the need changes over time. This model is not an acceptable model for the securities market as the individual entity is an unknown and the securitization of the mortgage becomes null and void due to the fact that a non-agency rated entity now has an interest in the mortgage asset. The present invention places the secondary market institution in the role of the lending institution, which carries substantial weight with securities investors and with borrowers. For borrowers, the present invention is an option made available to all that qualify, whereas an individual entity may not be available to the borrower, and/or may not be able to lend out the money at a reasonable lending rate. Additionally, a co-sign or addition to the mortgage document by a third party to provide borrower assistance now changes the credit perspective originally assigned to the mortgage because it now has to be underwritten again, another aspect that changes the likelihood of the mortgage being securitized legally.

Skip pay mortgages—the present invention carries with it a distinct and unique advantage for the purposes of securitizing this type of mortgage in the securities market. Due to the fact that a secondary market institution is subsidizing the borrower's payment, the investor pass-through of principal and interest is unaffected throughout the life of the loan, regardless of whether the borrower uses the flexible payment option or not. With the present invention, the borrower's payment is level as illustrated in FIG. 3. However, as one can see from FIG. 1, Skip Pay mortgages create inconsistent payments to investors over the life of the loan. Thus, the mortgage in a Skip Pay scenario must be removed from a securities pool in the market because it re-amortizes and has a different payment stream. This does not have to happen with the present invention, which can be held in an MBS and sold to all investors, not just held in an institution's retained portfolio (i.e., in a Fannie Mae or Freddie Mac internal investment portfolio). That is, when there is a non standard pass through of payments, those programs/products are typically placed in a retained portfolio in order to handle the inconsistent cash flows. With this product, the mortgage can be pooled and securitized and any investor can participate, not just a GSE retain portfolio, because the payment is normalized.

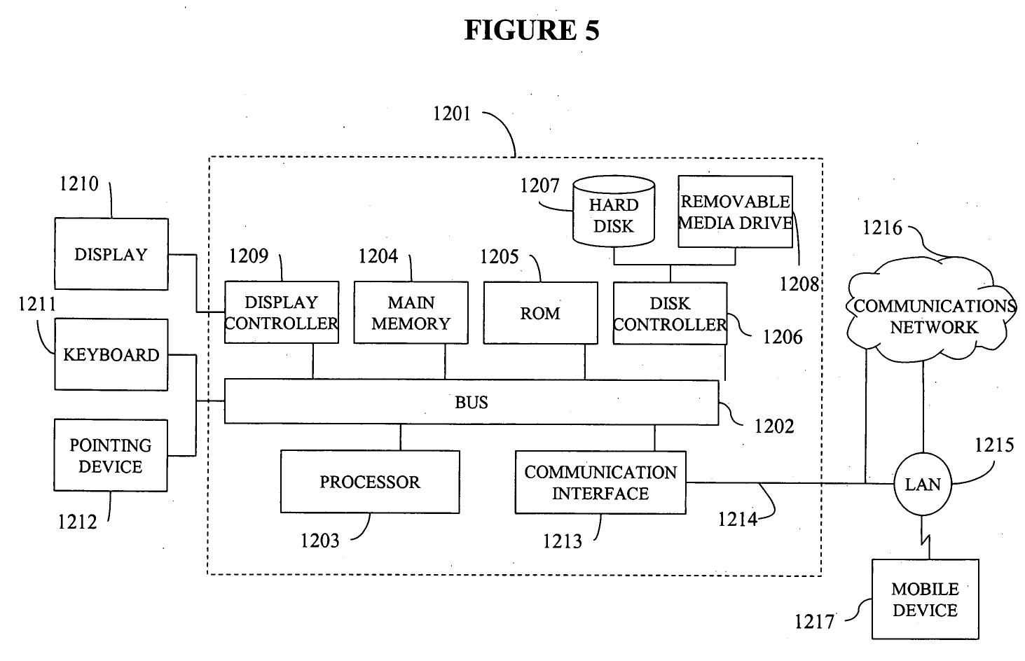

FIG. 5 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

1. A method of making and securing a loan, comprising the steps of:
guaranteeing by a guarantor a loan for real estate; and
administering said loan in accordance with a loan agreement having predetermined flexible payment terms that include
a borrower being responsible for a debt associated with said loan;
the guarantor paying at least a portion of an amount due on said loan behalf of the borrower; and
said guarantor taking an equity interest in said real estate in relation to said at least a portion of an amount due on said loan paid by the guarantor on behalf of the borrower.

2. The method of claim 1, wherein said at least a portion of an amount due comprises at least one of:
at least a portion of a principal payment;
at least a portion of an interest payment;
at least a portion of a tax payment; and
at least a portion of an insurance payment.

3. The method of claim 1, further comprising:
reselling said loan.

4. The method of claim 1, further comprising:
converting said loan from a first set of loan terms to said predetermined flexible payment terms of said loan agreement.

5. The method of claim 1, further comprising one of:
forwarding a decision to forgo said at least a portion of an amount due;
forwarding a request to forgo said at least a portion of an amount due; and
forgoing said at least a portion of an amount due without first forwarding a decision to forgo said at least a portion of an amount due and without first forwarding a request to forgo said at least a portion of an amount due.

6. The method of claim 5, wherein said at least a portion of an amount due is one of a portion fixed by the loan agreement and a portion selected by the borrower.

7. The method of claim 5, wherein said predetermined flexible payment terms include at least one of:
a life time cap on a number of deferments;
an annual cap on the number of deferments;
only allowing a deferment during a predetermined time period of the loan;
a life time cap on a dollar amount deferred; and
an annual cap on the dollar amount deferred.

8. The method of claim 5, wherein said one of forwarding a decision, forwarding a request, and forgoing said at least a portion of an amount due consists of:
forwarding said request, said method further comprising
evaluating said request at least to determine if said loan is compliant with a predetermined set of criteria related to current loan-to-value and payment history.

9. The method of claim 8, further comprising:
approving said request at an amount equal to or less than said at least a portion of an amount due requested by the borrower; and
informing the borrower of a revised payment due, said revised payment equal to an original obligation minus the amount approved in said step of approving.

10. The method of claim 5, further comprising:
notifying said guarantor that a payment is due from said guarantor on behalf of the borrower and in accordance with said predetermined flexible payment terms.

11. The method of claim 10, further comprising:
aggregating into a total payment a payment from the borrower and a payment from the guarantor; and
passing at least a portion of all collected interest from the total payment to a secondary market institution.

12. The method of claim 1 1, further comprising:
distributing the collected interest payments from the secondary market institution to secondary market investors.

13. The method of claim 12, wherein said step of distributing comprises:
bundling at least a portion of said loan with at least a portion of one or more additional loans.

14. The method of claim 13, further comprising:
capturing records of payments made by the guarantor on behalf of the borrower in a data warehouse.

15. The method of claim 13, further comprising:
calculating an equity share of the guarantor in said real estate corresponding to said payments made by the guarantor on behalf of the borrower.

16. The method of claim 15, further comprising:
assessing appreciation of said equity share when said borrower sells said real estate, at a time prior to when said borrower sells said real estate, when said borrower refinances said loan, or at a time prior to when said borrower refinances said loan.

17. The method of claim 16, further comprising one of:
the guarantor requesting an equity reimbursement from the borrower; and
the borrower voluntarily providing an equity reimbursement to said guarantor.

18. The method of claim 1, wherein said predetermined flexible payment terms include a penalty provision for default of one of said predetermined flexible payment terms.

19. The method of claim 18, wherein said predetermined flexible payment terms include a penalty provision for early liquidation of said equity share.

20. A system for making and securing a loan, comprising the steps of:
means for guaranteeing by a guarantor a loan for real estate; and
means for administering said loan in accordance with a loan agreement having predetermined flexible payment terms that include
a borrower being responsible for a debt associated with said loan;
the guarantor paying at least a portion of an amount due on said loan behalf of the borrower; and
said guarantor taking an equity interest in said real estate in relation to said at least a portion of an amount due on said loan paid by the guarantor on behalf of the borrower.

21. The system of claim 20, wherein said at least a portion of an amount due comprises at least one of:
at least a portion of a principal payment;
at least a portion of an interest payment;
at least a portion of a tax payment; and
at least a portion of an insurance payment.

22. The system of claim 20, further comprising:
means for converting said loan from a first set of loan terms to said predetermined flexible payment terms of said loan agreement.

23. The system of claim 20, further comprising:
means for notifying said guarantor that a payment is due from said guarantor on behalf of the borrower and in accordance with said predetermined flexible payment terms.

24. The system of claim 23, further comprising:
means for aggregating into a total payment a payment from the borrower and a payment from the guarantor; and
means for passing at least a portion of all collected interest from the total payment to a secondary market institution.

25. The system of claim 24, further comprising:
means for distributing the collected interest payments from the secondary market institution to secondary market investors.

26. The system of claim 25, wherein said means for distributing comprises:
means for bundling at least a portion of said loan with at least a portion of one or more additional loans.

27. The system of claim 24, further comprising:
means for capturing records of payments made by the guarantor on behalf of the borrower in a data warehouse.

28. The system of claim 24, further comprising:
means for calculating an equity share of the guarantor in said real estate corresponding to said payment made by the guarantor on behalf of the borrower.

29. The system of claim 28, further comprising:
means for assessing appreciation of said equity share when said borrower sells said real estate, at a time prior to when said borrower sells said real estate, when said borrower refinances said loan, or at a time prior to when said borrower refinances said loan.

30. A computer program product including instructions configured to enable a computer to perform a method for making and securing a loan, comprising instructions for:
guaranteeing by a guarantor a loan for real estate; and
administering said loan in accordance with a loan agreement having predetermined flexible payment terms that include
a borrower being responsible for a debt associated with said loan;
the guarantor paying at least a portion of an amount due on said loan behalf of the borrower; and
said guarantor taking an equity interest in said real estate in relation to said at least a portion of an amount due on said loan paid by the guarantor on behalf of the borrower.
